(19) United States
(12) Patent Application Publication
(10) Pub. No.: US 2024/0193411 A1
(43) Pub. Date: Jun. 13, 2024

(54) GENERATING CAUSAL ASSOCIATION RANKINGS USING DYNAMIC EMBEDDINGS

(71) Applicant: International Business Machines Corporation, Armonk, NY (US)

(72) Inventors: Jiri Navratil, Cortlandt Manor, NY (US); Karthikeyan Shanmugam, Bengaluru (IN); Naoki Abe, Rye, NY (US); Youssef Mroueh, New York, NY (US); Mattia Rigotti, Basel (CH); Inkit Padhi, White Plains, NY (US)

(21) Appl. No.: 18/062,673

(22) Filed: Dec. 7, 2022

(51) Int. Cl. G06N 3/08

(52) U.S. Cl. CPC G06N 3/08

(57) ABSTRACT

An embodiment for generating causal association rankings for candidate events within a window of candidate events using dynamic deep neural network generated embeddings. The embodiment may automatically receive a window of candidate events including events of a first type preceding one or more target events of interest. The embodiment may automatically generate contrastive windows of candidate events, each of the contrastive windows of candidate events of the first type corresponding to a different dropped candidate event from the received window of candidate events. The embodiment may automatically identify matching historical windows of events having resulting embeddings that are close in distance to the embeddings corresponding to the embeddings of the contrastive windows and calculate a first score for each match. The embodiment may automatically identify matching incident windows and calculate a corresponding second score. The embodiment may use the first and second scores to generate casual association rankings.

### BACKGROUND

The present application relates generally to computing and machine learning, and more particularly, to generating causal association rankings for candidate events within a window of candidate events using deep neural network generated embeddings.

Many businesses employ large scale information technology systems, such as cloud platforms, that are equipped with multiple layers of alerting mechanisms. Alerting mechanisms generate alerts for various events that have occurred based on anomaly detection engines utilizing various data sources, such as metric, trace and log data. As businesses grow in size and complexity, the number of alerts generated, and the number of events logged, may increase drastically. Managing of alerts and corresponding events allows businesses across a variety of domains to identify and manage resulting outcomes more effectively.

### SUMMARY

According to one embodiment, a method, computer system, and computer program product for generating causal association rankings for candidate events is provided. The embodiment may include automatically receiving a window of candidate events including events of a first type preceding one or more target events of interest of a second type, wherein the target events of interest of the second type include outcomes or incidents. The embodiment may also include automatically generating contrastive windows of candidate events of the first type preceding the one or more target events of interest, each of the contrastive window of candidate events of the first type corresponding to a different dropped candidate event of the first type from the received window of candidate events. The embodiment may further include automatically generating resulting embeddings for each of the generated contrastive windows of candidate events. The embodiment may also include automatically identifying matching historical windows of candidate events, the matching historical windows of candidate events including events of the first type preceding the one or more target events of interest of the second type, and having resulting embeddings that are below a predetermined threshold distance away from the resulting embeddings generated for a given generated contrastive window of candidate events. The embodiment may further include in response to identifying the matching historical windows of candidate events, automatically calculating and storing a corresponding first score for each of the matching historical window of candidate events. The embodiment may also include automatically identifying matching incident windows corresponding to each identified matching historical window, the matching incident windows having features or textual data corresponding to events of the second type that are above a predetermined similarity value threshold when compared to features or textual data corresponding to the one or more target events of interest, and subsequently calculating corresponding second scores for each of the identified matching incident windows. The embodiment may further include automatically calculating combined causal association scores using the first scores and the second scores, and using the combined causal association scores to generate causal association rankings for the events of the first type in the received window of candidate events.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment; and

FIG. 2 illustrates an operational flowchart for a process of generating causal association rankings for candidate events within a window of candidate events according to at least one embodiment;

FIG. 3 depicts an illustrative process for generating causal association rankings for candidate events within a window of candidate events according to at least one embodiment; and

FIG. 4 depicts an illustrative overview of an exemplary sequence-to-sequence autoencoder architecture.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to computing and machine learning, and more particularly, to generating causal association rankings for candidate events within a window of candidate events using deep neural network generated embeddings. The following described exemplary embodiments provide a system, method, and program product to, among other things, automatically receive a window of candidate events including events of a first type preceding one or more target events of interest of a second type, wherein the target events of interest of the second type includes outcomes or incidents, automatically generate contrastive windows of candidate events of the first type preceding the one or more target events of interest, each of the generated contrastive windows of candidate events of the first type corresponding to a different dropped candidate event of the first type from the received window of candidate events, and automatically generate resulting embeddings for each of the generated contrastive windows of candidate events. The described exemplary embodiments may then automatically identify matching historical windows of candidate events, the matching historical windows of candidate events including events of the first type preceding the one or more target events of interest of the second type, and having resulting embeddings that are below a predetermined threshold distance away from the resulting embeddings generated for a given generated contrastive window of candidate events, and in response to identifying the matching historical windows of candidate events, automatically calculate and store a corresponding first score for each of the matching historical window of candidate events. Thereafter, the described exemplary embodiments may then automatically identify matching incident windows corresponding to each identified matching historical window, the matching incident windows having features or textual data corresponding to events of the second type that are above a predetermined similarity value threshold when compared to features or textual data corresponding to the one or more target events of interest, and subsequently calculate corresponding second scores for each of the identified matching incident windows, and then automatically calculate combined causal association scores using the first scores and the second scores, and using the combined causal association scores to generate causal association rankings for the events of the first type in the received window of candidate events. Therefore, the presently described embodiments have the capacity to improve managing of computer incidents and events using machine learning by providing a method of generating causal association rankings for multiple candidate events within a received window of candidate events by using generated dynamic embeddings to identify events that are impactful in causing the occurrence of an incident or outcome by comparing embeddings of both the detected windows of events and previously stored (i.e. historic) windows of events, specifically by leveraging potential outcome frameworks and using generated contrastive windows of events to determine a missing event's impact in influencing the occurrence of an outcome or incident.

As previously described, many businesses employ large scale information technology (IT) systems, such as cloud platforms, that are equipped with multiple layers of alerting mechanisms. Alerting mechanisms generate alerts for various events that have occurred based on anomaly detection engines utilizing various data sources, such as metric, trace and log data. As businesses grow in size and complexity, the number of alerts generated and the number of events logged may increase drastically. Managing computer incidents and events corresponding to computer incident alerts allows businesses across a variety of domains to identify and manage resulting outcomes more effectively.

With the prevalence of digital disruption across many industries, many businesses and their brand power are highly dependent on the reliability and resilience of their IT operations. Today's IT environments are increasingly more complex, with the migration to cloud platforms introducing additional layers of virtualization while enabling a greater degree of flexibility and agility. It is critical, therefore, that intelligent automated systems accompany these advancements that can provide actionable insights to assist the site reliability engineers' (SRE's) efforts to resolve the various performance issues that arise in that complex environment. Large scale IT systems, such as cloud platforms, are equipped with multiple layers of alerting mechanisms, based on anomaly detection engines using various data sources, such as metric, trace and log data. The daily job of an SRE, however, tends to be overwhelmed by the floods of these alerts, resulting in what has been referred to as the “alert fatigue.” To help make the SRE's work more efficient, therefore, it is desirable to select a small subset of those alerts that are directly relevant. This would also be beneficial in other domains, such as, for example, fraud detection in financial transactions, or treatment analysis and pharmaceutical interaction in medical domains.

There are several machine learning approaches that have been explored to address the challenges of alert fatigue, including clustering and supervised classification of alerts into high priority versus low priority alerts. However, these approaches are unable to identify and pinpoint a root cause of a target incident or outcome. Identifying and pinpointing alerts containing events corresponding to the root cause of a given outcome or incident, from among the potentially numerous smaller issues which may manifest themselves as alerts is highly desirable, as it allows personnel to more efficiently address a given incident in a more timely and direct manner.

Accordingly, a method, computer system, and computer program product for improved methods of generating causal association rankings for candidate events using deep neural network generated embeddings would benefit many businesses that struggle to manage large volumes of alerts and corresponding events generated over time by allowing the businesses to identify which events are the root cause of a given outcome or incident. The method, system, and computer program product may automatically receive a window of candidate events including events of a first type preceding one or more target events of interest of a second type, wherein the target events of interest of the second type include outcomes or incidents. The method, system, computer program product may automatically generate contrastive windows of candidate events of the first type preceding the one or more target events of interest, each of the generated contrastive window of candidate events of the first type corresponding to a different dropped candidate event of the first type from the received window of candidate events. The method, system, computer program product may automatically generate resulting embeddings for each of the generated contrastive windows of candidate events. The method, system, computer program product may then automatically identify matching historical windows of candidate events, the matching historical windows of candidate events including events of the first type preceding the one or more target events of interest of the second type, and having resulting embeddings that are below a predetermined threshold distance away from the resulting embeddings generated for a given generated contrastive window of candidate events. Then, the method, system, computer program product may, in response to identifying the matching historical windows of candidate events, automatically calculate and store a corresponding first score for each of the matching historical window of candidate events. Next the method, system, computer program product may automatically identify matching incident windows corresponding to each identified matching historical window, the matching incident windows having features or textual data corresponding to events of the second type that are above a predetermined similarity value threshold when compared to features or textual data corresponding to the one or more target events of interest, and subsequently calculate corresponding second scores for each of the identified matching incident windows. Thereafter, the method, system, computer program product may automatically calculate combined causal association scores using the first scores and the second scores, and using the combined causal association scores to generate causal association rankings for the events of the first type in the received window of candidate events. In turn, the method, system, computer program product has provided improved methods for generating causal association rankings for candidate events using dynamic deep neural network generated embeddings. Described embodiments provide a method of generating causal association rankings for multiple candidate events within a received window of candidate events by using generated dynamic embeddings to identify events that are impactful in causing the occurrence of an incident or outcome by comparing embeddings of both the detected windows of events and previously stored (i.e. historic) windows of events, specifically by leveraging potential outcome frameworks and using generated contrastive windows of events to determine a missing event's impact in influencing the occurrence of an outcome or incident. The generated causal association rankings are highly valuable datapoints that may be used by the personnel of a business to identify alerts and events that may be the root cause of a given incident or outcome, thereby allowing the personnel to resolve unfavorable outcomes or incidents more efficiently.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

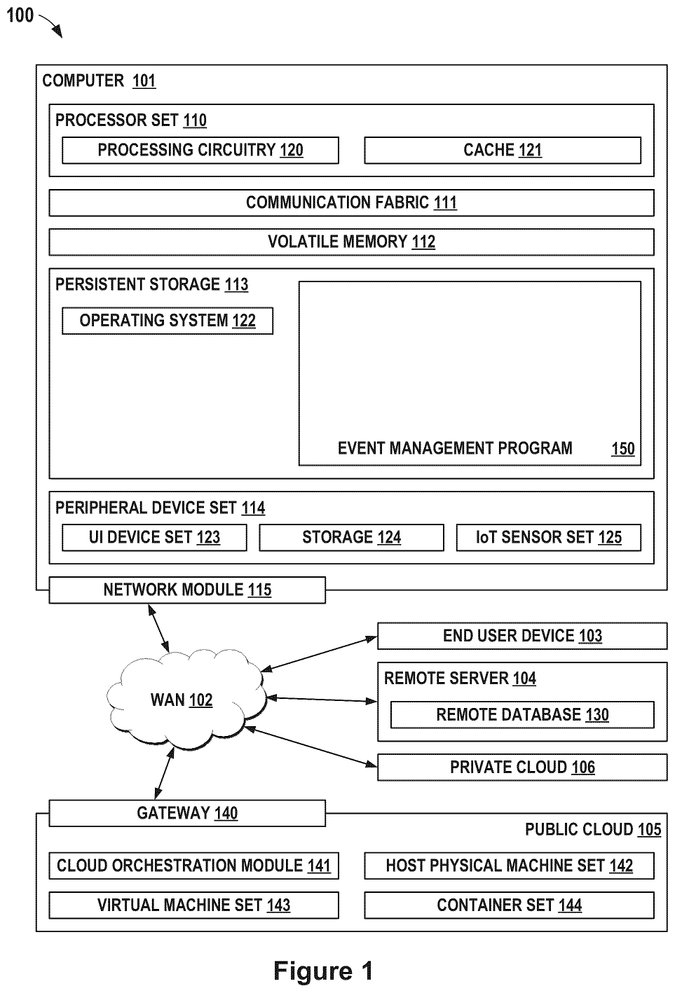

Referring now to FIG. 1, computing environment 100 contains an example of an environment for the execution of at least some of the computer code involved in performing the inventive methods, such as event management program/code 150. In addition to event management code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and event management code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in event management code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in event management code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the event management program 150 may be a program capable of automatically receiving a window of candidate events including events of a first type preceding one or more target events of interest of a second type, wherein the target events of interest of the second type include outcomes or incidents. Event management program 150 may then automatically generate contrastive windows of candidate events of the first type preceding the one or more target events of interest, each of the generated contrastive window of candidate events of the first type corresponding to a different dropped candidate event of the first type from the received window of candidate events. Next, event management program 150 may automatically generate resulting embeddings for each of the generated contrastive windows of candidate events. Event management program 150 may then automatically identify matching historical windows of candidate events, the matching historical windows of candidate events including events of the first type preceding the one or more target events of interest of the second type, and having resulting embeddings that are below a predetermined threshold distance away from the resulting embeddings generated for a given generated contrastive window of candidate events. Next, event management program 150 may, in response to identifying the matching historical windows of candidate events, automatically calculate a corresponding first score for each of the matching historical window of candidate events. Then, event management program 150 may automatically identify matching incident windows corresponding to each identified matching historical window, the matching incident windows having features or textual data corresponding to events of the second type that are above a predetermined similarity value threshold when compared to features or textual data corresponding to the one or more target events of interest, and subsequently calculate corresponding second scores for each of the identified matching incident windows. Thereafter, event management program 150 may automatically calculate combined causal association scores using the first scores and the second scores, and use the combined causal association scores to generate causal association rankings for the events of the first type in the received window of candidate events Described embodiments provide provided improved methods for generating causal association rankings for candidate events using dynamic deep neural network generated embeddings. Described embodiments provide a method of generating causal association rankings for multiple candidate events within a received window of candidate events by using generated dynamic embeddings to identify events that are impactful in causing the occurrence of an incident or outcome by comparing embeddings of both the detected windows of events and previously stored (i.e. historic) windows of events, specifically by leveraging potential outcome frameworks and using generated contrastive windows of events to determine a missing event's impact in influencing the occurrence of an outcome or incident. The generated causal association rankings are valuable datapoints that may be used by the personnel of a business to identify alerts and events that may be the root cause of a given incident or outcome, thereby allowing the personnel to resolve unfavorable outcomes or incidents more efficiently.

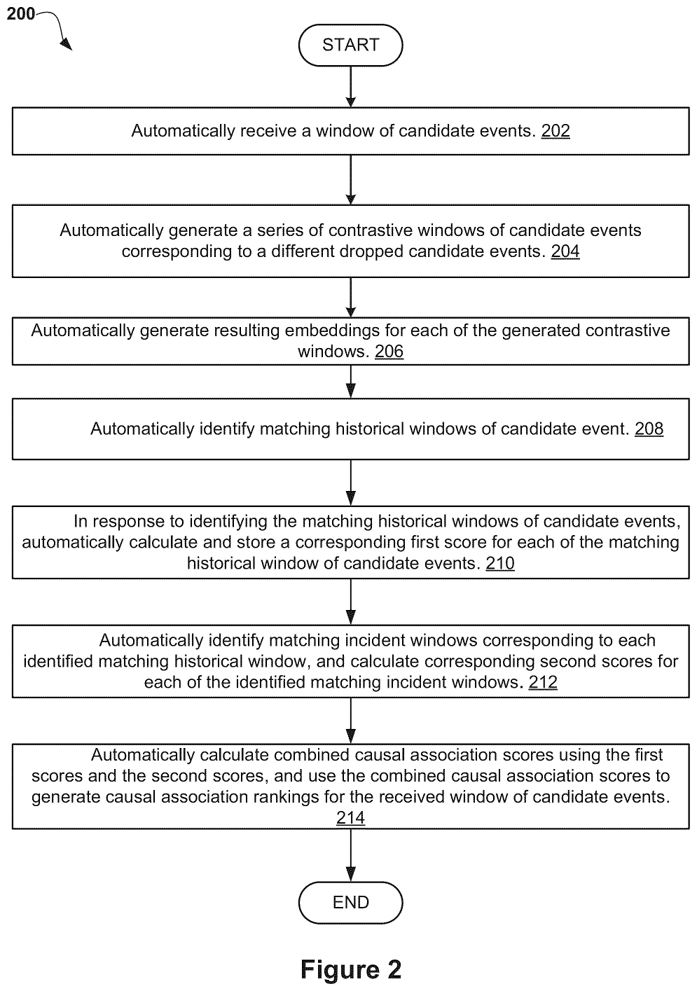

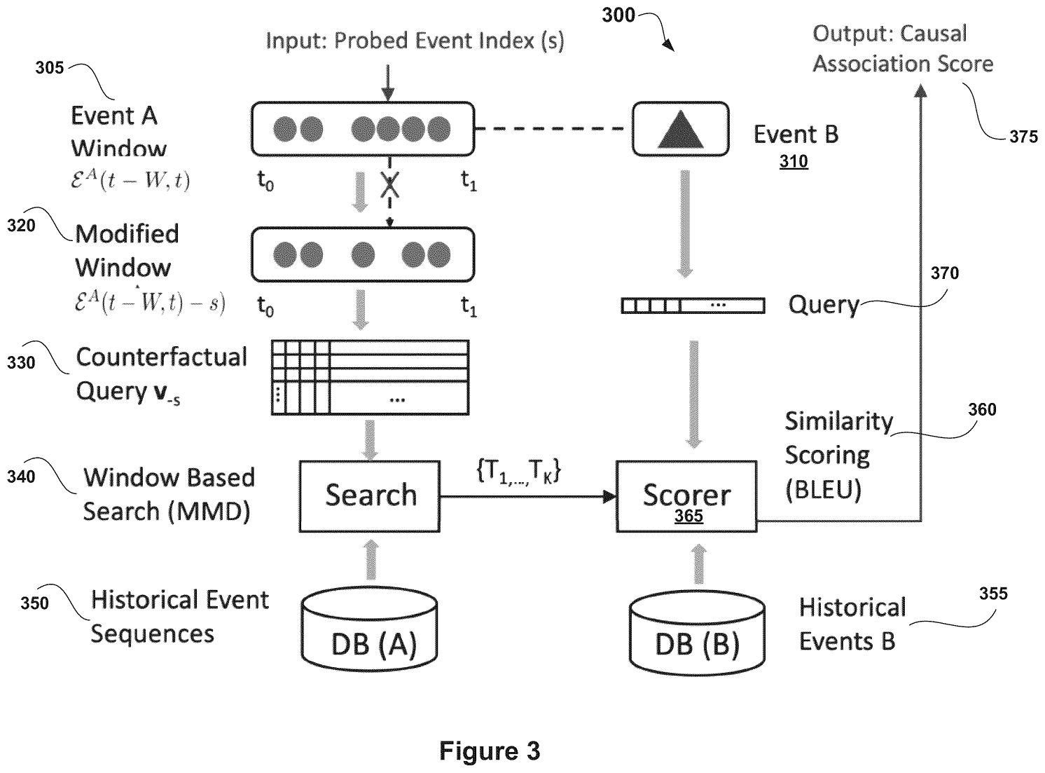

Referring now to FIG. 2, an operational flowchart for a process 200 of generating causal association rankings for multiple candidate events within a received window of candidate events according to at least one embodiment is provided. Process 200 may be further understood in view of diagram 300 depicted in FIG. 3. FIG. 3 will be referenced throughout the description of process 200 and throughout the discussion of an accompanying example in which event management program 150 is employed to manage multiple incident alerts received within an IT operations management domain.

At 202, event management program 150 may automatically receive a window of candidate events including events of a first type preceding one or more target events of interest of a second type, the target events of interest of the second type including outcomes or incidents. For example, if employed in an IT operations management domain, event management program may, at 202, automatically receive a window of candidate events including events of a first ‘Type A’ and events of a second ‘Type B’. In this example, event management program 150 may receive a Window of Events X including some Type A events, each type A event corresponding to specific alerts, and further including some Type B events, each type B event corresponding to a given ‘incident’. In the IT operations management domain, an incident may include, for example, a server going offline, a device malfunctioning, or a network-wide outage. The received window of candidate events may be received by event management program 150 as an ‘event sequence’ including a collection of time-stamped descriptions of events occurring within the exemplary system employing event management program 150. Event management program 150 may be configured to consider two types of events in the detected event sequence, as discussed above. The first type of events (Type A in the example above) may generally include lower-level alerts (or simply alerts) that get triggered by rules designed to track events from lower-level metrics in an IT system. Events of the second type (Type B events in the example above) may represent incidents or outcomes which correspond to detected problems with human denoted descriptions that could be caused by a lower-level issue or event of the first type. This may trigger multiple lower-level alerts. Event management program 150 may be configured to identify sets of keys for the two types of event sequences. For example, in the IT operations management domain, event management program 150 may recognize the keys for incidents as Type B events to include resources and free text descriptions, while keys for alerts as Type A events may include event types, severity, resources, and some textual descriptions.

In embodiments, ε^{A} and ε^{B} may represent two types of event sequence for Type A events and Type B events respectively. Formally. both ε^{A} and ε^{B} may be a list of tuples where each tuple is of the form (tᵢ, Lᵢ) where tᵢ∈ [symbol] is a time stamp and where Lᵢ is a list of key, value pairs. The keys may come from a fixed set K, where Lᵢ=(k, mᵢ, [k])k∈K. For each k∈K, the value segment mᵢ[k] is an ordered sequence of word tokens from a fixed dictionary of word tokens W. For example, mᵢ[k]∈W*={(w₁, w₂ . . . w₃): n∈N, wᵢ∈W}. To determine causation or impact for a given event, event management program 150 may be configured to assume that the occurrence (t, L^{B}) of event of type B at a specific time t may be a poisson process governed by a conditional intensity function that depends on the past occurrences in the event sequence ε^{A} as follows:

$$λ ( 〈 t , {ℒ}^{B} 〉 \vert {ε}^{A} [ - ∞ , t ] ) = \{ \begin{matrix}λ ( 〈 t , {ℒ}^{B} 〉 \vert {ε}^{A} [ t - B - D , t - D ] ) \\ 0\end{matrix} \begin{matrix}〈 t , {ℒ}^{B} 〉 ∉ if {ε}^{B} [ - ∞ , t ] \\ Otherwise\end{matrix} \} \qquad ( 1 )$$

Step 202 of process 200 is visually depicted in diagram 300 of FIG. 3. FIG. 3 shows an exemplary Event A Window 305 that may be detected by event management program 150. Each event is represented at 305 by an individual oval shape inside the detected window of events, each event having a specific time stamp represented by the position of each oval within the window.

Next, at 204, event management program 150 may automatically generate contrastive windows of candidate events of the first type preceding the one or more target events of interest, each of the generated contrastive window of candidate events of the first type corresponding to a different dropped candidate event of the first type from the received window of candidate events. In other words, event management program 150 may sequentially drop a singular event from the detected window to generate a series of contrastive windows having a given singular event missing. This is depicted visually by modified window 320 of FIG. 3, where an individual event from Event A Window 305 has been removed to generate a contrastive window at 320. These contrastive windows are ultimately used to form corresponding counterfactual queries (See 330 in FIG. 3) that may be utilized by event management program 150 to match each contrastive window to a series of previously stored historical windows of candidate events at 208 (discussed in greater detail below). At this step, event management program 150 may further engage in sequence processing steps that are ultimately helpful for forming the contrastive windows that may ultimately be used as counterfactual queries (V₋ₛ). For example, in the IT operations management domain example used above, event management program 150 may encode the alert events using multisegment one-shot encoding to extract features of a given alert. Event management program 150 may further convert arbitrary timestamps to time-equidistant timestamps, i.e., aligning events to a uniform grid.

At 206, event management program 150 may automatically generate resulting embeddings for each of the generated contrastive windows of candidate events. To accomplish this, event management program 150 may first apply a sliding window of a certain length as a hyperparameter. As a result, a sequence of overlapping windows each consisting of a fixed number of encoded alert/event vectors (possibly including ‘padding’ vectors that indicate an unoccupied slot). Event management program 150 may utilize a recurrent neural network (RNN) embedder to transform each window from this step into a single vector, distilling the structural as well as temporal information. Thus, event management program 150 encodes each event along with its along with its temporal context (preceding alerts). Event management program 150 may utilize a long short-term memory (LSTM) based encoder-decoder architecture trained as an auto-encoder. This provides the benefit of allowing for the use of unlabeled data with event management program 150. For example, event management program 150 may implement the auto-encoder in Tensorflow, and may further provide a command-line interface to enable a user to run training of the deep neural network on separate machines. It should be noted that this type of embedder may be sensitive to the order of alerts and is trained on many historical sequences. Thus, by removing a single alert from the window, the embedder may be expected to generate an approximation of a counterfactual/contrastive window, accounting for the window dynamics. For example event management program 150 may generate an exemplary dynamic RNN embedding R:ε^{A}(t−W, t)→v where v∈ [symbol] ^{(m×n)} where m is the embedding dimension and n is the number of embedding vectors in the window, and an exemplary contrastive or counterfactual window in which one event is dropped is represented by R:ε^{A}(t−W, t)−s). In other embodiments, event management program 150 may utilize other types of networks for this step, such as, for example, transformer networks, convolutional neural networks, or fully connected networks. In other embodiments, event management program 150 may similarly automatically utilize a transformer architecture trained using event and event-field masking configured to use unlabeled data and to transform each of the generated contrastive windows into a vector distilling both temporal and structural information.

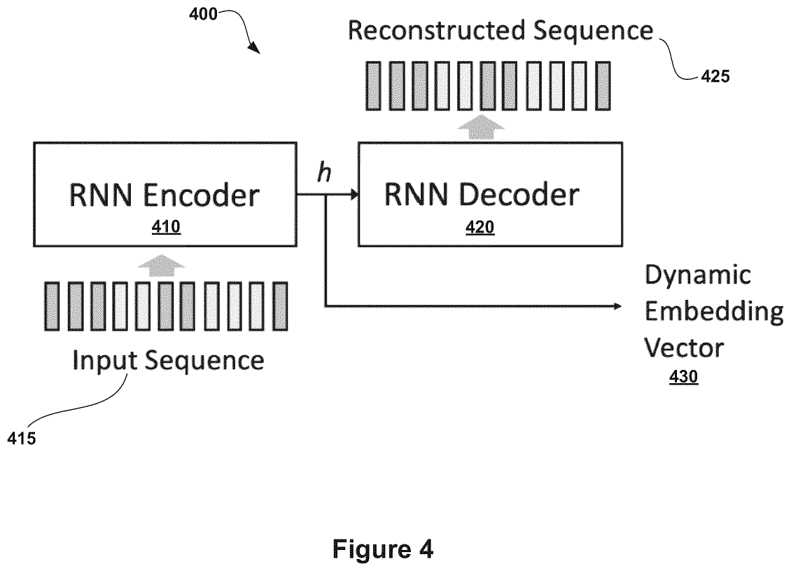

FIG. 4 depicts an overview of an exemplary encoder-decoder architecture 400. As shown, presently described embodiments may utilize an RNN encoder 410 to receive an input sequence 415. RNN encoder 410 may include an RNN (LSTM) cell responsible for processing sequences 415 while updating its hidden state, a vector h. The final state is passed to an RNN Decoder 420 configured to reproduce input sequence 415 based solely on the hidden state to output a reconstructed sequence 425. Thus, when trained properly, the hidden state carries a compressed representation of the entire sequential input. The vector h serves as the dynamic embeddings 430 of the events {t, L_{A}} in the context of an input sequence ε^{A}(t₀,t).

At 208, event management program 150 may automatically identify matching historical windows of candidate events, the matching historical windows of candidate events including events of the first type preceding the one or more target events of interest of the second type, and having resulting embeddings that are below a predetermined threshold distance away from the resulting embeddings generated for a given generated contrastive window of candidate events. In other words, event management program 150 will compare the resulting embeddings generated for each contrastive window of events with the resulting embeddings of a series of stored historical windows of events to identify matching historical windows that are similar to a given contrastive window. Once a counterfactual query (corresponding to a contrastive window) has been formed in the preceding steps, (see counterfactual query 330 in FIG. 3) event management program 150 accomplishes the matching of contrastive windows to historical windows by performing a search within a database of historical events or alerts. (See FIG. 3 including window-based search 340 and Historical Event Sequences 350 including DB(A), i.e. database A) The database may be implemented as a simple file system based cache. The contrastive window (Vₛ) represents a counterfactual window that is then used as a query in a search over the stored database of historical windows. In embodiments, event management program 150 utilizes a kernel-based Maximum Mean Discrepancy (MMD) method to compare the two sets of windows of candidate events. This search returns the top K closest windows in terms of their MMD distances to the counterfactual query being considered (m₁, m₂, . . . ,mₖ) and the corresponding historical candidate window end times (T₁, . . . Tₖ). Thus, event management program 150 has identified matching historical windows that match with the contrastive windows in terms of distance measured between embeddings.

In embodiments, event management program 150 may apply Random Fourier Features (RFF) during search, retrieval, and indexing of the historical windows of candidate events. The RFFs represent each window with a single vector. In other word, event management program 150 may generate pre-computed summary vectors for the historical windows of candidate events. These vectors may then be indexed using a hierarchical k-Nearest Neighbor (kNN) structure. When retrieval is performed, kNN may then be used to quickly find the single vector and multiply it by a given counterfactual query, as discussed above to search over the stored databases of historical windows of events, which will functionally allow for more efficient approximation of the corresponding MMD distances.

At 210, in response to identifying the matching historical windows of candidate events, event management program 150 may automatically calculate and store a corresponding first score for each of the matching historical window of candidate events. The first score may correspond to an MMD score as determined above in connection with step 208. These MMD scores for the type A events in the matching historical windows of candidate events may then be stored by event management program 150 for later use in calculating causal association rankings, as will further be discussed below.

At 212, event management program 150 may automatically identify matching incident windows corresponding to each identified matching historical window, and calculate corresponding second scores for each of the identified matching incident windows. For each match m discovered, event management program 150 will query (See query 370 in FIG. 3) a database of historical windows (See Database DB(B) of Historical Events B 355 in FIG. 3) of a predetermined length, for example 8 hours, to search for matching historical incidents or outcomes followed by the occurrence of matched event m. For example, event management program 150 may pre-process exemplary observed type B events, [symbol] , [symbol] _{obs}^{B} [symbol] and create a query q [symbol] t, [symbol] _{obs}^{B} [symbol] . This will cause event management program 150 to span candidate search windows of length W_{B} at one of end times T₁ . . . ,T_{K}, within a database of historical (factual) events of type B, letting ε^{B} (Tⱼ, Tⱼ+W_{B}) be a set of type B events falling within the window starting at time T₁.

Event management program 150 then compares any matches found to an original incident (i.e. the target type B event) and calculates a corresponding second scores including Bilingual Evaluation Understudy (BLEU) scores between the description fields (textual data) and features of the individual incidents. (See Similarity Scoring 360 in FIG. 3) This scoring method is useful for comparing candidate translations of text to one or more reference translation, in this case, comparing the textual data and features of the individual incidents in the matching historical window of candidate events to the Type B target event of interest in the received window of candidate events from step 202. Event management program 150 has thus compared the outcomes in terms of event type B (incidents or outcomes) having {t, L_{B)}).

At 214, event management program 150 may automatically calculate combined causal association scores using the first scores and the second scores, and use the combined causal association scores to generate causal association rankings for the events of the first type in the received window of candidate events. The combined casual association score represents the causal impact that a given Type A event has on bringing about the Type B target event. At this step event management program 150 may utilize a scorer 365 (shown in FIG. 3) to process the first scores and second scores as inputs to generate a combined causal association score. In embodiments, second scores (BLEU scores) are weighted using the first scores (MMD scores) resulting in a single score per event removed when generating the contrastive windows, thus providing an indicator for the impact the removal has caused. In embodiments, the casual association score between a type A event, s= [symbol] ₛ, [symbol] ^{A} [symbol] , and a type B event [symbol] t, [symbol] _{obs}^{B} [symbol] may be calculated using the following exemplary formula:

$${r}_{- s} = {\sum }_{k = 1}^{K} {α}_{k} Sim [ q ( {ℒ}_{obs}^{B} ) , {ℰ}^{B} ( {T}_{k} , {T}_{k} + {W}_{B} ) ] \\ {α}_{k} = \frac{( 1 - {m}_{k} )}{{\sum }_{j}^{K} ( 1 - {m}_{j} )}$$

In the above formula, the variables correspond to those described in the above-discussed examples with Sim being a metric quantifying similarity between the type B query and the factual Type B records found within the search window W_{B}.

Once a set of K impact scores are obtained, event management program 150 may use them to generate causal association rankings to rank the individual events or alerts in the originally detected window, and their amplitude is an indication of their casual association with the target event. A list of events and their causal association rankings for the target event may be outputted to a user by any suitable means through a convenient user interface.

It will be appreciated that event management program 150 thus provides improved methods for generating causal association rankings for candidate events using dynamic deep neural network generated embeddings. Described embodiments provide a method of generating causal association rankings for multiple candidate events within a received window of candidate events by using generated dynamic embeddings to identify events that are impactful in causing the occurrence of an incident or outcome by comparing embeddings of both the detected windows of events and previously stored (i.e. historic) windows of events, specifically by leveraging potential outcome frameworks and using generated contrastive windows of events to determine a missing event's impact in influencing the occurrence of an outcome or incident. Furthermore, event management program 150 allows for users to achieve this result without the need for labeled data. The causal association rankings generated by event management program 150 are highly valuable datapoints that may be used by the personnel of a business to identify alerts and events that may be the root cause of a given incident or outcome, thereby allowing the personnel to resolve unfavorable outcomes or incidents more efficiently.

While an exemplary IT operations management domain is discussed above in connection with described embodiments, it is to be understood that event management program 150 may be utilized across a variety of domains to establish causal association rankings for a variety of alerts or events to determine casual impact of individual events in bringing about different types of incidents or outcomes. For example, in some embodiments, event management program 150 may be utilized for financial fraud monitoring, in which alerts and events of interest may be financial transactions, such as those involving credit cards. In other embodiments, event management program 150 may be utilized for treatment analysis or monitoring of pharmaceutical interactions in medical domains.

It may be appreciated that FIG. 2 provides only illustrations of an exemplary implementation and does not imply any limitations with regard to how different embodiments may be implemented. Many modifications to the depicted environment may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of generating causal association rankings for candidate events comprising:
automatically receiving a window of candidate events including events of a first type preceding one or more target events of interest of a second type, wherein the target events of interest of the second type comprise outcomes or incidents;
automatically generating contrastive windows of candidate events of the first type preceding the one or more target events of interest, each of the generated contrastive windows of candidate events of the first type corresponding to a different dropped candidate event of the first type from the received window of candidate events;
automatically generating resulting embeddings for each of the generated contrastive windows of candidate events;
automatically identifying matching historical windows of candidate events, the matching historical windows of candidate events including events of the first type preceding the one or more target events of interest of the second type, and having resulting embeddings that are below a predetermined threshold distance away from the resulting embeddings generated for a given generated contrastive window of candidate events;
in response to identifying the matching historical windows of candidate events, automatically calculating and storing a corresponding first score for each of the matching historical window of candidate events;
automatically identifying matching incident windows corresponding to each identified matching historical window, the matching incident windows having features or textual data corresponding to events of the second type that are above a predetermined similarity value threshold when compared to features or textual data corresponding to the one or more target events of interest, and subsequently calculating corresponding second scores for each of the identified matching incident windows; and
automatically calculating combined causal association scores using the first scores and the second scores, and using the combined causal association scores to generate causal association rankings for the events of the first type in the received window of candidate events.

2. The computer-based method of claim 1, wherein the generated resulting embeddings for each of the generated contrastive windows of candidate events comprise dynamic embeddings generated using one of, a recurrent neural network, a convolutional neural network, a transformer network, or a fully connected network.

3. The computer-based method of claim 1, wherein automatically identifying matching historical windows of candidate events, the matching historical windows of candidate events including events of the first type preceding the one or more target events of interest of the second type, and having resulting embeddings that are below a predetermined threshold distance away from the resulting embeddings generated for a given generated contrastive window of candidate events further comprises:
automatically utilizing a kernel-based Maximum Mean Discrepancy (MMD) process to determine the distance between embeddings of counterfactual queries corresponding to generated contrastive windows being considered and embeddings corresponding to a given historical candidate window.

4. The computer-based method of claim 3, wherein the given historical windows of candidate events are indexed in a hierarchical structure based on pre-computed summary vectors, the pre-computed summary vectors being computed using an average of Random Fourier Features corresponding to the given historical candidate windows.

5. The computer-based method of claim 1, wherein the corresponding second scores for each of the identified matching incident windows comprise Bilingual Evaluation Understudy (BLEU) scores.

6. The computer-based method of claim 1, further comprising:
automatically utilizing a long short-term memory (LSTM) based encoder-decoder architecture trained as an auto-encoder that is configured to use unlabeled data and to transform each of the generated contrastive windows into a vector distilling both temporal and structural information.

7. The computer-based method of claim 1, further comprising:
automatically outputting to a user a list of individual events of the first type from the window of candidate events, the list of individual events being sorted by their respective generated causal association rankings.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
automatically receiving a window of candidate events including events of a first type preceding one or more target events of interest of a second type, wherein the target events of interest of the second type comprise outcomes or incidents;
automatically generating contrastive windows of candidate events of the first type preceding the one or more target events of interest, each of the generated contrastive windows of candidate events of the first type corresponding to a different dropped candidate event of the first type from the received window of candidate events;
automatically generating resulting embeddings for each of the generated contrastive windows of candidate events;
automatically identifying matching historical windows of candidate events, the matching historical windows of candidate events including events of the first type preceding the one or more target events of interest of the second type, and having resulting embeddings that are below a predetermined threshold distance away from the resulting embeddings generated for a given generated contrastive window of candidate events;
in response to identifying the matching historical windows of candidate events, automatically calculating and storing a corresponding first score for each of the matching historical window of candidate events;
automatically identifying matching incident windows corresponding to each identified matching historical window, the matching incident windows having features or textual data corresponding to events of the second type that are above a predetermined similarity value threshold when compared to features or textual data corresponding to the one or more target events of interest, and subsequently calculating corresponding second scores for each of the identified matching incident windows; and
automatically calculating combined causal association scores using the first scores and the second scores, and using the combined causal association scores to generate causal association rankings for the events of the first type in the received window of candidate events.

9. The computer system of claim 8, wherein the generated resulting embeddings for each of the generated contrastive windows of candidate events comprise dynamic embeddings generated using one of, a recurrent neural network, a convolutional neural network, a transformer network, or a fully connected network.

10. The computer system of claim 8, wherein automatically identifying matching historical windows of candidate events, the matching historical windows of candidate events including events of the first type preceding the one or more target events of interest of the second type, and having resulting embeddings that are below a predetermined threshold distance away from the resulting embeddings generated for a given generated contrastive window of candidate events further comprises:
automatically utilizing a kernel-based Maximum Mean Discrepancy (MMD) process to determine the distance between embeddings of counterfactual queries corresponding to generated contrastive windows being considered and embeddings corresponding to a given historical candidate window.

11. The computer system of claim 10, wherein the given historical windows of candidate events are indexed in a hierarchical structure based on pre-computed summary vectors, the pre-computed summary vectors being computed using an average of Random Fourier Features corresponding to the given historical candidate windows.

12. The computer system of claim 8, wherein the corresponding second scores for each of the identified matching incident windows comprise Bilingual Evaluation Understudy (BLEU) scores.

13. The computer system of claim 8, further comprising:
automatically utilizing a long short-term memory (LSTM) based encoder-decoder architecture trained as an auto-encoder that is configured to use unlabeled data and to transform each of the generated contrastive windows into a vector distilling both temporal and structural information.

14. The computer system of claim 8, further comprising:
Automatically outputting to a user a list of individual events of the first type from the window of candidate events, the list of individual events being sorted by their respective generated causal association rankings.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
automatically receiving a window of candidate events including events of a first type preceding one or more target events of interest of a second type, wherein the target events of interest of the second type comprise outcomes or incidents;
automatically generating contrastive windows of candidate events of the first type preceding the one or more target events of interest, each of the generated contrastive windows of candidate events of the first type corresponding to a different dropped candidate event of the first type from the received window of candidate events;
automatically generating resulting embeddings for each of the generated contrastive windows of candidate events;
automatically identifying matching historical windows of candidate events, the matching historical windows of candidate events including events of the first type preceding the one or more target events of interest of the second type, and having resulting embeddings that are below a predetermined threshold distance away from the resulting embeddings generated for a given generated contrastive window of candidate events;
in response to identifying the matching historical windows of candidate events, automatically calculating and storing a corresponding first score for each of the matching historical window of candidate events;
automatically identifying matching incident windows corresponding to each identified matching historical window, the matching incident windows having features or textual data corresponding to events of the second type that are above a predetermined similarity value threshold when compared to features or textual data corresponding to the one or more target events of interest, and subsequently calculating corresponding second scores for each of the identified matching incident windows; and
automatically calculating combined causal association scores using the first scores and the second scores, and using the combined causal association scores to generate causal association rankings for the events of the first type in the received window of candidate events.

16. The computer program product of claim 15, wherein the generated resulting embeddings for each of the generated contrastive windows of candidate events comprise dynamic embeddings generated using one of, a recurrent neural network, a convolutional neural network, a transformer network, or a fully connected network.

17. The computer program product of claim 15, wherein automatically identifying matching historical windows of candidate events, the matching historical windows of candidate events including events of the first type preceding the one or more target events of interest of the second type, and having resulting embeddings that are below a predetermined threshold distance away from the resulting embeddings generated for a given generated contrastive window of candidate events further comprises:
automatically utilizing a kernel-based Maximum Mean Discrepancy (MMD) process to determine the distance between embeddings of counterfactual queries corresponding to generated contrastive windows being considered and embeddings corresponding to a given historical candidate window.

18. The computer program product of claim 17, wherein the given historical windows of candidate events are indexed in a hierarchical structure based on pre-computed summary vectors, the pre-computed summary vectors being computed using an average of Random Fourier Features corresponding to the given historical candidate windows.

19. The computer program product of claim 15, wherein the corresponding second scores for each of the identified matching incident windows comprise Bilingual Evaluation Understudy (BLEU) scores.

20. The computer program product of claim 15, further comprising:
automatically utilizing a long short-term memory (LSTM) based encoder-decoder architecture trained as an auto-encoder that is configured to use unlabeled data and to transform each of the generated contrastive windows into a vector distilling both temporal and structural information.
